(19) United States
(12) Patent Application Publication
(10) Pub. No.: US 2007/0113464 A1
(43) Pub. Date: May 24, 2007

(54) Electrical mosquito swatter with airflow generating means

(76) Inventor: Ming Lan, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/653,268

(22) Filed: Jan. 16, 2007

(30) Foreign Application Priority Data
Jul. 6, 2005 (TW) 94122934

(51) Int. Cl. A01M 3/02

(52) U.S. Cl. 43/137

(57) ABSTRACT

An electrical mosquito swatter includes a swatter body has an electric surface switched within the frame thereof, a battery mounted in the handle and controlled by a control switch set to raise a voltage on the electric surface for electrocuting insects, and an electric fan mounted inside the handle and controlled by the control switch to causes currents of air toward air outlets on the oval frame of the swatter body around the electric surface to force insets toward the center area of the electric surface.

### BACKGROUND OF THE INVENTION

1. Field of the Invention

The present invention relates to home environmental hygiene and more specifically, to an electrical mosquito swatter with airflow generating means

2. Description of the Related Art

People may use an electrical mosquito swatter to kill mosquitoes and any other insets. However, when wielding the electrical mosquito swatter to make mosquitoes touch the electric surface, a wind pressure is produced. Because mosquitoes and insects are sensitive to wind pressure, mosquitoes and insets will soon fly away when the user is wielding the electrical mosquito swatter. Although a conventional electrical mosquito swatter has a broad electric surface, it still cannot kill mosquitoes and insects efficiently.

### SUMMARY OF THE INVENTION

The present invention has been accomplished under the circumstances in view. It is therefore the main object of the present invention to provide an electrical mosquito swatter, which is controllable to generate a flow of air that forces insects to fly toward the electric surface.

To achieve this and other objects of the present invention, the electrical mosquito swatter comprises a swatter body, the swatter body comprising a handle and a frame fixedly connected to one end of the handle, an electric surface formed of positive and negative electric wires and stretched within the frame, an airflow passage defined within the frame around the electric surface, a plurality of air outlets formed on the frame in air communication with the airflow passage, a control switch set mounted on the handle, a battery mounted inside the handle and controllable by the control switch set to raise a voltage on the electric surface, and an electric fan mounted inside the handle and controllable by the control switch set to causes currents of air toward the airflow passage and the air outlets.

### BRIEF DESCRIPTION OF THE DRAWINGS

FIG. 1 is a front view of an electrical mosquito swatter in accordance with the present invention.

FIG. 2 is a sectional view of the electrical mosquito swatter according to the present invention.

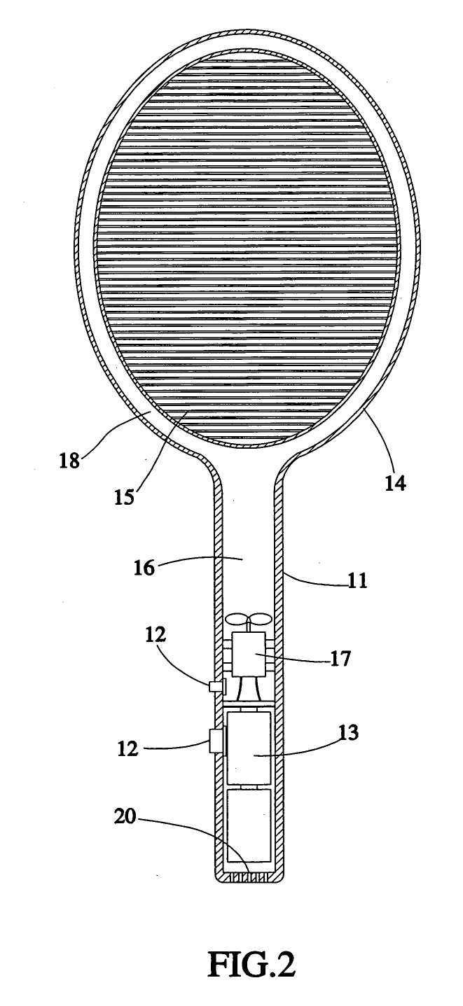

FIG. 3 is a sectional view taken along line 3-3 of FIG. 1.

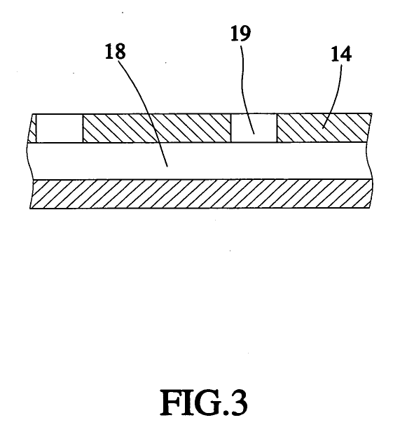

FIG. 4 is a sectional view of an alternate form of the electrical mosquito swatter according to the present invention.

### DETAILED DESCRIPTION OF THE INVENTION

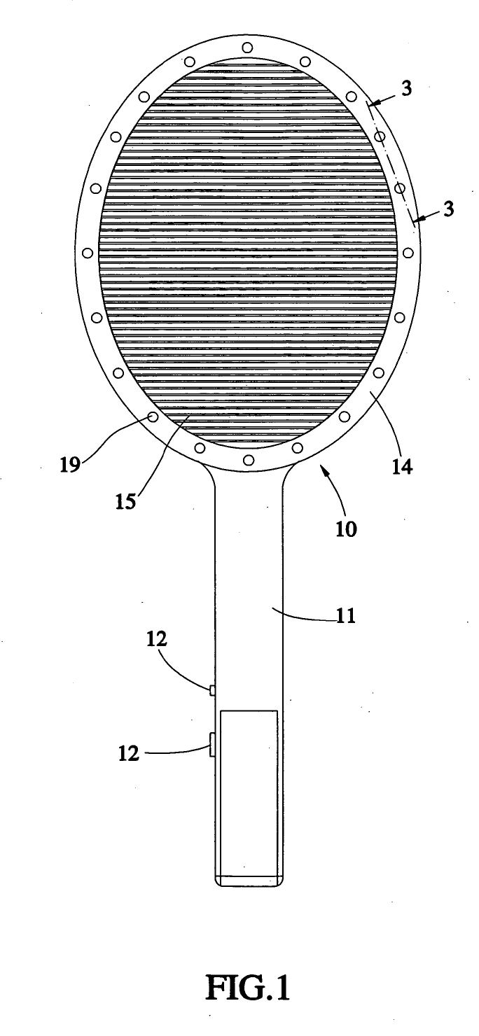

Referring to FIG. 1˜3, an electrical mosquito swatter in accordance with the present invention is shown comprising a swatter body 10. The swatter body 10 has a handle 11 and a frame 14 at one end of the handle 11. Positive and negative electric wires are stretched within the frame 14, thereby forming an electric surface 15 for electrocuting any mosquitoes, insects, fly's, or any other pests on contact. A control switch set 12 is mounted on the handle 11. A battery 13 is mounted inside the handle 11 and controllable by the control switch set 12 to raise voltage on the electric surface 15.

Further, the handle 11 has an accommodation chamber 16. An electric fan 17 is mounted inside the accommodation chamber 16 and electrically connected to the battery 13 through the control switch set 12. The frame 14 provides an airflow passage 18 therein around the electric surface 15, and has a plurality of air outlets 19 disposed on one side of the oval frame 14 around the electric surface 15 in air communication with the airflow passage 18. The air outlets 19 slope in direction toward the electric surface 15. The handle 11 further has a plurality of air inlets 20 on its one end for guiding in outside air.

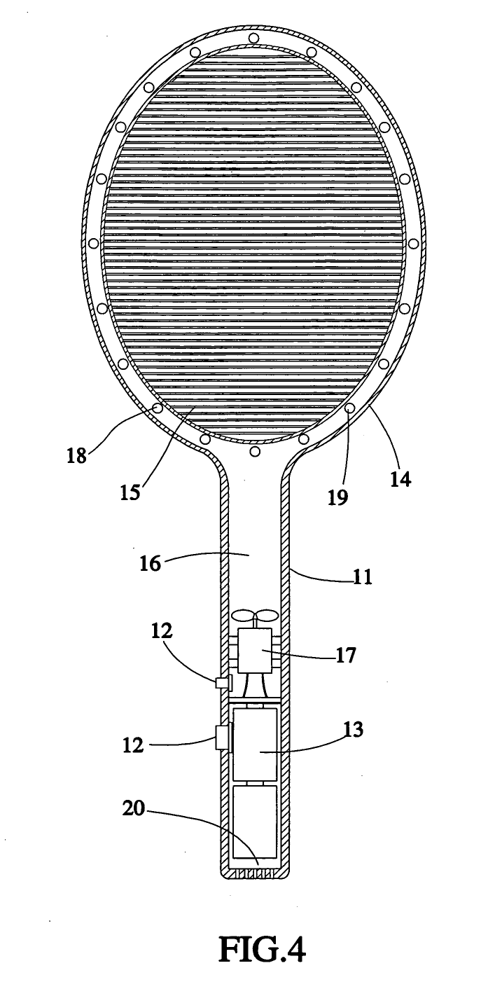

FIG. 4 shows an alternate form of the present invention. This embodiment is substantially similar to the embodiment shown in FIGS. 1˜3 with the exception that the air outlets 19 are formed on both sides of the frame 14 around the electric surface 15 in air communication with the airflow passage 18.

When in use, hold the handle 11 of the swatter body 10 and switch on the electric fan 17 and the electric surface 15, and then wield the swatter body 10 to make mosquitoes touch the electric surface 15. At this time, currents of air flow out of the air outlets 19 around the electric surface 15. Therefore, a flow of air is produced around the electric surface 15 to force mosquitoes toward the center area of the electric surface 15, and the user can kill mosquitoes and other inserts with the electrical mosquito swatter efficiently without wielding the electrical mosquito swatter with force.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electrical mosquito swatter comprising a swatter body, said swatter body comprising a handle and an frame fixedly connected to one end of said handle, an electric surface formed of electric wires and stretched within said frame, an airflow passage defined within said frame around said electric surface, a plurality of air outlets formed on said oval frame in air communication with said airflow passage, a control switch set mounted on said handle, a battery mounted inside said handle and controllable by said control switch set to raise a voltage on said electric surface, and an electric fan mounted inside said handle and controllable by said control switch set to causes currents of air toward said airflow passage and said air outlets.

2. The electrical mosquito swatter as claimed in claim 1, wherein said air outlets slope in direction toward said electric surface.

3. The electrical mosquito swatter as claimed in claim 1, wherein said air outlets are formed on two opposite sides of said oval frame around said electric surface.

4. The electrical mosquito swatter as claimed in claim 1, wherein said handle has a plurality of air inlets for guiding in outside air toward said electric fan and said airflow passage.
